(19) United States
(12) Patent Application Publication
(10) Pub. No.: US 2015/0056594 A1
(43) Pub. Date: Feb. 26, 2015

(54) SYSTEMS AND METHODS FOR MEASURING EDUCATIONAL INPUTS

(71) Applicant: David Andrew Blake, Alpine, UT (US)

(72) Inventor: David Andrew Blake, Alpine, UT (US)

(21) Appl. No.: 13/972,767

(22) Filed: Aug. 21, 2013

(51) Int. Cl. G09B 5/00

(52) U.S. Cl. CPC G09B 5/00
USPC 434/322

(57) ABSTRACT

A computer-implemented method for measuring educational inputs is described. A plurality of educational inputs are obtained. The inputs may include at least one formal educational input and at least one informal educational input. A value for each educational input is determined. Each determined value is normalized with respect to other determined values. An educational achievement is determined based on at least one of the determined values.

### BACKGROUND

Educational learning has typically been viewed as including only formal educational learning. In general, formal educational learning is provided by formal accredited institutions (e.g., schools, colleges, universities). Educational providers generally track educational achievement by awarding degrees. Accordingly, educational achievement is generally measured in terms of the types of degrees earned, discipline of the degree, strength of the institution, etc. Thus, in one example, a person may measure education as earning a Bachelor of Science degree in Economics from a particular education.

However, formal educational learning may be only a small portion of a person's total educational learning. For example, a person may continually learn from informal educational providers throughout the person's life. Informal educational learning opportunities are widely available. Unfortunately, current education achievement measures do not consider the educational learning provided by these informal educational providers. Furthermore, measuring educational learning based on degrees earned may not adequately reflect the educational learning provided by a formal educational provider. For example, a person may take additional courses not required for the degree or may drop out of school without earning a degree. Thus, even with regards to formal educational learning, traditional academic achievement measures may not adequately capture actual educational achievement.

### SUMMARY

According to at least one embodiment, a computer-implemented method for measuring educational inputs is described. A plurality of educational inputs are obtained. A value for each educational input is determined. Each determined value is normalized with respect to other determined values. An educational achievement is determined based on at least one of the determined values.

In some cases, the plurality of educational inputs may include at least one informal educational input. In some cases, the plurality of educational inputs may include at least one formal educational input. In some embodiments, the educational achievement may be determined by combining at least one determined value for the at least one informal educational input and at least one determined value for the at least one formal educational input.

In some cases, a learning velocity may be determined for each educational input. In some embodiments, determining the value for each educational input may include determining the value for each educational input based on the learning velocity of each educational input.

In some cases, a weighting may be determined for each educational input. A rank may also be determined for each educational input. In some embodiments, determining the value for each educational input may include determining the value for each educational input based on the weighting and the rank of each educational input.

In some embodiments, an educational equivalency may be determined based at least in part on the educational achievement. In some embodiments, an educational goal may be generated. At least one pathway for achieving the educational goal may be identified. The pathway may be based on the determined educational equivalency.

In some embodiments, each of the determined values may be categorized. In some cases, the determined values may be combined based on category. A category measurement may be determined for at least one category based on the combined determined values. In some embodiments, at least one of the plurality of educational inputs may be validated.

A device configured to measure educational inputs is also described. The device includes a processor and memory in electronic communication with the processor. The device includes instructions stored in the memory. The instructions are executable by the processor to obtain a plurality of educational inputs, determine a value for each educational input, wherein each determined value is normalized with respect to other determined values, and determine an educational achievement based on at least one of the determined values.

A computer-program product to measure educational inputs is additionally described. The computer-program product includes a non-transitory computer-readable medium having instructions thereon. The instructions being executable by a processor to obtain a plurality of educational inputs, determine a value for each educational input, wherein each determined value is normalized with respect to other determined values, and determine an educational achievement based on at least one of the determined values.

Further scope of the applicability of the described methods and apparatuses will become apparent from the following detailed description, claims, and drawings. The detailed description and specific examples are given by way of illustration only, since various changes and modifications within the spirit and scope of the description will become apparent to those skilled in the art.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram illustrating one embodiment of an environment in which the present systems and methods may be implemented;

FIG. 2 is a block diagram illustrating one embodiment of an education equivalence module;

FIG. 3 is a block diagram illustrating one embodiment of an education measurement module;

FIG. 4 is a block diagram illustrating one embodiment of an equivalency determination module;

FIG. 5 is a block diagram illustrating one embodiment of a pathway generation module;

FIG. 6 illustrates an exemplary environment in which the present systems and method may be implemented;

FIG. 7 is a flow diagram illustrating one embodiment of a method to measure educational inputs;

FIG. 8 is a flow diagram illustrating one embodiment of a method to identify at least one pathway for achieving an educational goal;

FIG. 9 is a flow diagram illustrating one embodiment of a method to determine educational achievement based on educational inputs from different educational providers;

FIG. 10 depicts a block diagram of a computer system suitable for implementing the present systems and methods.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

Educational achievement has traditionally been measured in terms of degrees earned at formal accredited institutions (e.g., schools, colleges, universities). For example, a person's educational achievement may be measured in terms of receiving a bachelors of science degree in economics from a first university and a masters in business administration (MBA) degree from a second university. Since a person generally only attends a few formal educational providers (e.g., formal accredited institutions, measuring and keeping track of educational achievement has traditionally been straightforward. However, this approach to measuring educational achievement may not adequately reflect the educational achievement of a person. For example, some students that attend formal educational institutions may not graduate with a degree. Unfortunately, educational achievement associated with unfinished degrees or classes taken outside of the degree requirements go unmeasured.

Furthermore, learning is not confined to the few years spent attending a formal educational institutions. Instead, learning may come from a variety of educational providers (e.g., formal and informal) throughout a person's lifetime. Opportunities for informal education have increased dramatically in recent years. For example, many universities have begun offering online courses to the public. For instance, OpenCourseWare Consortium, edX, iTunesU, Academic Earth, all offer free online courses. Therefore, a person's educational achievement may include learning from both formal and informal educational providers. Accordingly, a new approach for measuring educational achievement that measures learning from formal and/or informal educational providers is needed.

The systems and methods described herein allow for formal and/or informal educational inputs to be measured into a person's educational achievement.

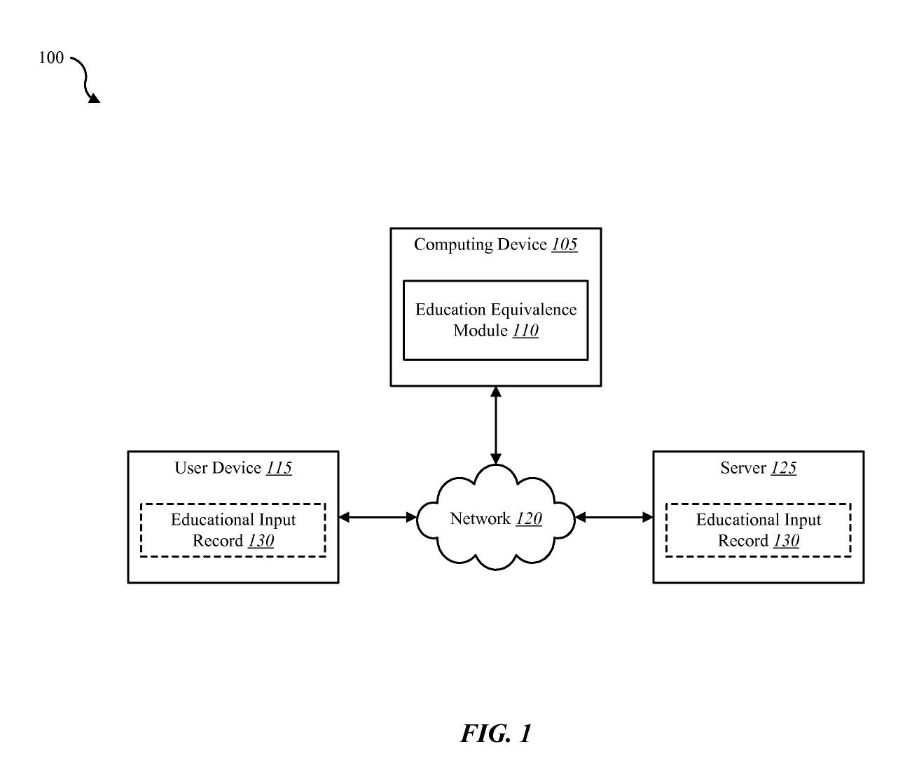

Turning now to the Figures, FIG. 1 is a block diagram 100 illustrating one embodiment of an environment in which the present systems and methods may be implemented. In one embodiment, a computing device 105 may communicate with a user device 115 and/or a server 125 through a network 120. Network 120 may be the Internet. In one example, the network 120 may include one or more local area networks (LAN), wide area networks (WAN), and/or personal area networks (PAN). For example, the network 120 may include wired networks, wireless networks, cellular networks, and/or satellite networks. Examples of computing devices 105 include cell phones, tablets, laptop computers, desktop computers, servers, network appliances, etc. In some embodiments, user device 115 and/or server 125 may be examples of computing devices.

In one embodiment a computing device 105 may include an education equivalence module 110. The education equivalence module 110 may obtain at least one educational input record 130 and may determine at least one educational measurement based on the at least one educational input record 130. For example, the education equivalence module 110 may obtain a formal educational input record 130 and an informal educational input record 130 and may determine an educational achievement based at least on the formal educational input record 130 and the informal educational input record 130. In one embodiment, the education equivalence module 110 may be a web based service (e.g., software as a service (SaaS)).

In one example, a user may upload/submit one or more educational input records 130 to the educational equivalence module. For example, the user device 115 may upload an unofficial transcript (e.g., a collection of formal educational input records 130) to the education equivalence module 110. Additionally or alternatively, the user device 115 may submit an indication that the user completed an online course on iTunesU, watched a TED talk, read a book, etc. (e.g., an informal educational input record 130) to the education equivalence module 110. The education equivalence module 110 may receive the educational input record(s) (e.g., formal and/or informal) and may determine at least one educational achievement for a user based on the received educational input record(s).

In another example, the education equivalence module 110 may communicate with the server 125 and may automatically check whether the server 125 includes one or more educational input records 130. For instance, the server 125 may be associated with an edX course and an educational input record 130 may be an indication that a particular edX course has been completed. In some cases, the education equivalence module 110 may receive user account information for a user and may access the educational input record 130 on the server 125 using the received user account information. In one example, a user, using the user device 115 may consume an educational video (a TED talk video, for example) via the server 125. The educational equivalence module 110 may automatically fetch the educational input record 130 associated with the consumed educational video and may determine an educational achievement based at least in part on the educational input record. In another example, a user may indicate completion of an educational input and an educational input record 130 may be generated by the user device 115.

In one embodiment, the education equivalence module 110 may determine a measure (e.g., a score) associated with each educational input (formal and/or informal, for example). The education equivalence module 110 may then aggregate the educational measures associated with multiple educational inputs to determine an educational achievement of the user.

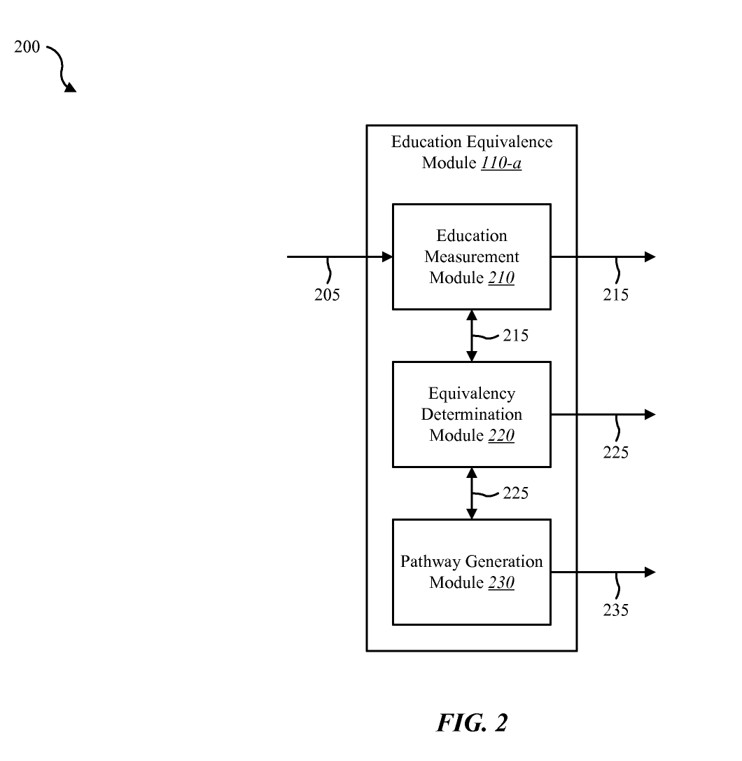

FIG. 2 is a block diagram 200 illustrating one embodiment of an education equivalence module 110-a. The education equivalence module 110-a may be an example of the education equivalence module 110 illustrated in FIG. 1. In one embodiment, the education equivalence module 110-a may include an education measurement module 210, an equivalency determination module 220, and a pathway generation module 230.

The education measurement module 210 may receive one or more educational inputs (e.g., inputs 205) and may assign an educational measurement (e.g., score) to each educational input. In some cases, the education measurement module 210 may aggregate educational measurements associated multiple educational inputs (formal and informal educational inputs, for example). The education measurement module 210 may output educational measurements for each of the educational inputs and/or may output aggregate educational measurements (e.g., measurements 215). In some cases, the measurements 215 may be output for display. For instance, a display may indicate each educational input and the measurement assigned to the educational input. Additionally or alternatively, the display may display aggregate measurement information. Details regarding the education measurement module 210 are described below.

The equivalency determination module 220 may receive the measurements 215 and may determine an educational achievement associated with the measurements 215. The equivalency determination module 220 may analyze the educational achievement with respect to various degree requirements and may determine an educational equivalency (e.g., equivalency with respect to one or more formalized degree requirements). For instance, the equivalency determination module 220 may analyze the course requirements for completing a particular degree, determine equivalent measurements for the various course requirements, and may analyze the educational achievement (e.g., the measurements associated with each of the user's educational inputs and/or the aggregate measurements associated with the user's educational inputs). For example, the equivalency determination module 220 may determine (based on the various educational measurements of the user's earned educational inputs, for example) that a user's combination of educational inputs is equivalent to a bachelors degree in marketing of a top 100 school. In another example, the equivalency determination module 220 may determine that a user's combination of educational inputs is equivalent to a sophomore level achievement in pursuit of a bachelors degree in marketing of a top 100 school. The equivalency determination module 220 may output (e.g., achievement equivalency 225) the determined educational achievement and/or the determined educational equivalency. In some cases, the achievement equivalency 225 may be output for display. For instance, a display may indicate the determined educational achievement and/or the educational equivalency associated with the determined educational achievement. Details regarding the equivalency determination module 220 are described below.

The pathway generation module 230 may receive the achievement equivalency 225 and may generate one or more pathways for accomplishing an educational goal. In one example, the educational goal may be completion of the degree requirements associated with the determined educational equivalency. In another example, one or more educational goals may be automatically selected based on the trajectory (e.g., trajectory of the user's educational inputs) of the user's educational achievement. For instance, the pathway generation module 230 may determine an educational goal based on an analysis of the discipline and course area (e.g., categories) of the educational inputs (e.g., formal courses, informal inputs). In some cases, the pathway generation module 230 may suggest one or more various possible educational inputs for satisfying one or more requirements of the determined educational goal. For instance, the pathway generation module 230 may determine the educational measurement that is lacking between the user's educational measurements and the required level of educational measurements and may suggest one or more possible educational inputs that (on their own, or in combination, for example) may fulfill the lacking educational measurements associated with the educational goal. For instance, if the equivalency determination module 220 determines that the educational achievement is equivalent to a sophomore level of achievement for a bachelors degree in marketing, the pathway generation module 230 may suggest various educational inputs (e.g., informal educational inputs) that would help satisfy the corresponding educational measurements required for completing the requirements for a bachelors degree in marketing. In some embodiments, the pathway generation module 230 may output (e.g., pathway 235) a generated pathway and/or suggested educational inputs that may be pursued to satisfy the requirements of an educational goal. In some cases, the pathway 235 may be output for display. For instance, a display may indicate the educational goal (e.g., user selected or determined) and various educational inputs that may be pursued that would help fulfill the remaining requirements of the educational goal. In some cases, the pathway generation module 230 may indicate the impact of various combinations suggested educational inputs (e.g., tracks for completing the remaining requirements). Details regarding the pathway generation module 230 are described below.

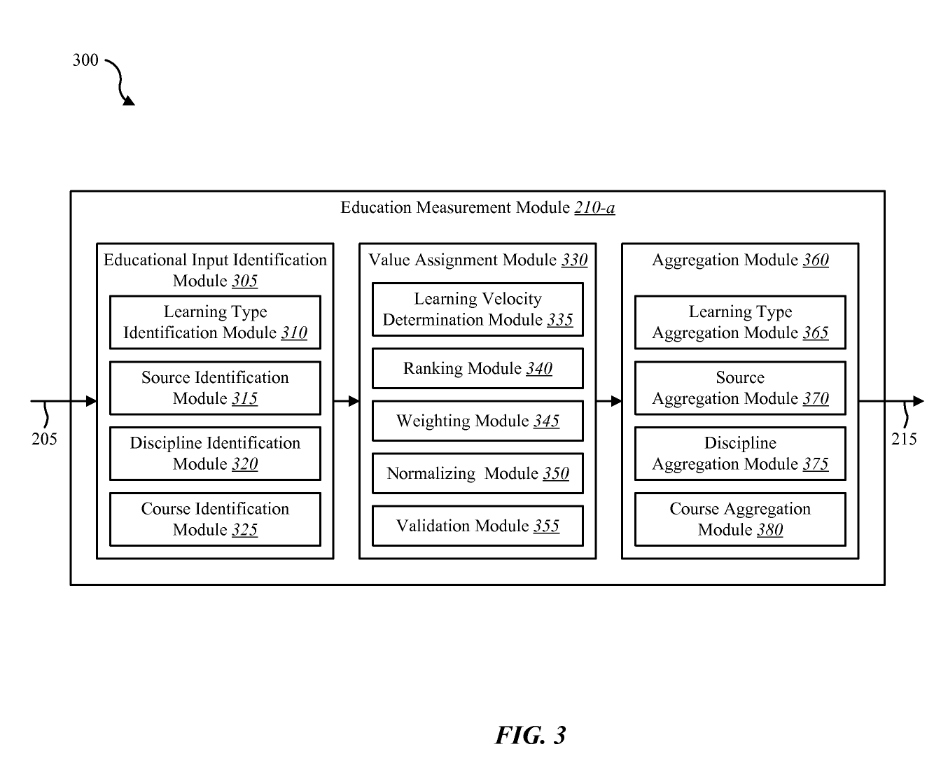

FIG. 3 is a block diagram 300 illustrating one embodiment of an education measurement module 210-a. The education measurement module 2110-a may be an example of the education measurement module 210 illustrated in FIG. 2. The education measurement module 210-a may include an educational input identification module 305, a value assignment module 330, and an aggregation module 360.

The educational input identification module 305 may analyze and identify educational inputs (e.g., inputs 205). For example, the educational input identification module 305 may identify various characteristics associated with each educational input. In some cases, the educational input identification module 305 may include a learning type identification sub module 310, a source identification sub module 315, a discipline identification sub module 320, and a course identification sub module 325.

The learning type identification sub module 310 may identify the learning type associated with an educational input. Examples of learning types include attending an accredited course in person, taking an accredited course online, taking an unaccredited course online, attending a seminar, watching an educational video, reading an educational book, reading an educational article, etc.

The source identification sub module 315 may identify the source of an educational input. Examples of sources include schools, colleges, universities, online course providers, educational video providers, peer-reviewed articles, articles, textbooks, books, symposiums, conferences, etc. In some cases, the source identification module 315 may identify the particular university attended, the particular department within the university attended, and the particular course taken within the department and university.

The discipline identification sub module 320 may identify the discipline and/or field of study associated with a particular input. Examples of disciplines include mathematics, sciences, english, history, general, education, physics, geography, engineering, economics, business, etc. In some cases, disciplines may refer to general categories while field of study may correspond to more particular fields (e.g., possible degree programs) within a discipline. Examples of fields of study include mechanical engineering, electrical engineering, statistics, marketing, accounting, social work, etc.

The course identification sub module 235 may identify the course and or specific area of education covered by an educational input. Examples of courses in the mathematics discipline include geometry, trigonometry, calculus, linear algebra, differential equations, partial differential equations, etc. In some cases, course identification may allow for more precise educational input comparison and mapping. In some cases, course information may easily be obtained (from a transcript, for example). In other cases, course information may be approximated based on the learning type of the educational input and information about the educational input.

The value assignment sub module 330 may analyze information identified about an educational input and may assign a value (e.g. a score) to the educational input based on the identified information. In some cases, the value assignment module 330 may include a learning velocity determination sub module 335, a ranking sub module 340, a weighting sub module 345, a normalizing sub module 350, and a validation sub module 355.

The learning velocity determination sub module 335 may determine a learning velocity associated with an educational input. In one example, learning velocity may correspond to the rate of learning associated with an educational input. In some cases, different learning types may have different learning velocities. For example attending an accredited course at a university may be more rigorous (e.g., have a higher learning velocity) than reading a book. In some cases, learning velocity may be used as a tool to determine normalize different learning types with respect to each other. As a result, values assigned to different educational inputs may correspond to an appropriate measure of the educational learning (e.g., rigorous learning) associated with completing that educational input. In some cases, an educational input with higher learning velocity may be assigned a higher score than an educational input with a lower learning velocity.

The ranking sub module 340 may rank sources of educational input within a particular learning type. For example, universities may be ranked with respect to each other. In one example, educational inputs from a university that is one of the best universities in the world may be assigned a higher value than the same educational input received at a top 100 university or a lower tier university.

The weighting sub module 345 may weight different portions of a value with respect to other portions. For instance, in the case of formal educational input, the weighting module 345 may weigh the rank of the source (including the weight of the department, for example) with a weight of the discipline and/or a weight for the course.

The normalizing sub module 350 may normalize values with respect to each other. For example, the normalizing sub module 350 may normalize the educational measures determined for each educational input so that different educational measures for different educational inputs (e.g., formal, informal, inputs of different types, etc.) may be accurately aggregated and/or compared with each other.

The validation sub module 355 may validate educational inputs to ensure accuracy. In the case of formal educational inputs (e.g., courses taken at an accredited institution) an unofficial transcript may be verified and validated by comparing it with an official transcript (provided by the institution, for example). In the case of informal educational inputs, assertions that an educational input has been completed may be validated by checking with the educational provider to verify and validate that the educational input was completed. In some cases, the validation module 355 may connect (e.g., automatically connect) to a server (e.g., server 125) to validate an educational input. In some cases, each educational input may be validated. In other cases, only a portion of the educational inputs may be validated. In one example, the educational measure associated with an unvalidated educational input maybe lower than the educational measure for the same educational input that has been validated.

The aggregation module 360 may aggregate one or more educational measures. In some cases, each of the educational measures may be aggregated (e.g., grouped, combined, summed) to determine an overall educational achievement. Additionally or alternatively, the aggregation module 360 may aggregate one more educational measures based on characteristics associated with the underlying educational input. In some cases the aggregation module 360 may determine a sum of the aggregated educational measures. In other cases, the aggregation module 360 may group aggregated educational measures together. For example, the aggregation module 360 may categorize educational measures (e.g., by learning type, by source educational provider, by discipline, by field, by course, etc) based on the underlying educational input and may group the educational measures based on category. In some cases, the aggregation module 360 may aggregate (e.g., combine) educational measures based on group (e.g., category). For example, the aggregation module 360 may include a learning type aggregation sub module 365, a source aggregation sub module 370, a discipline aggregation sub module 375, and a course aggregation sub module 380.

The learning type aggregation sub module 365 may aggregate educational measures of educational inputs of one or more learning types. For example, the aggregation sub module 365 may aggregate the educational measures associated with formal educational inputs into a first aggregate value and may aggregate educational measures associated with informal educational inputs into a second aggregate value. In another example, the aggregation sub module 365, may aggregate educational measures based on the identified learning type of each educational input.

The source aggregation sub module 370 may aggregate educational measures associated with educational inputs based on the source of the educational inputs. For example, the source aggregation sub module 370 may aggregate together educational measures associated with educational inputs from a particular source (e.g., a particular university).

The discipline aggregation sub module 375 may aggregate educational measures based on the discipline of the underlying educational inputs. For example, educational measures associated with educational inputs under the mathematics discipline may be aggregated together.

The course aggregation sub module 380 may aggregate educational measures based on the course of the underlying educational inputs. For example, educational measures associated with educational inputs of different calculus courses (e.g., different levels of calculus) may be aggregated together.

Using the various modules and sub modules described above, the education measurement module 210-a may analyze an educational input and may assign an educational measure (e.g., a score) to the educational input so that the educational measures of different educational inputs may be analyzed together. The education measurement module 210-a may output 215 an educational measure for each educational input. Additionally or alternatively, the education measurement module 210-a may output 215 one or more aggregate values based on the characteristics of the underlying educational inputs.

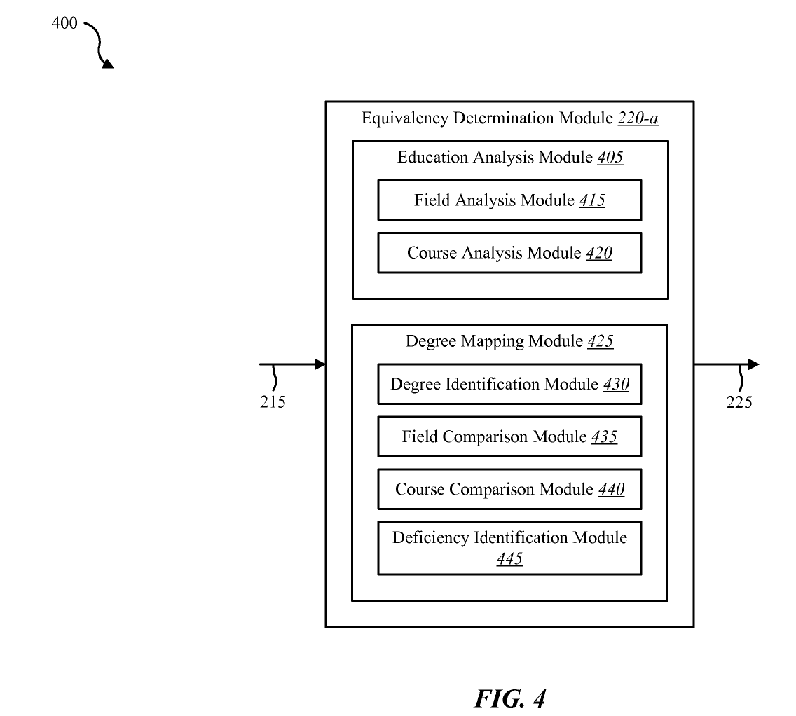

FIG. 4 is a block diagram 400 illustrating one embodiment of an equivalency determination module 220-a. The equivalency determination module 220-a may be an example of the equivalency determination module 220 illustrated in FIG. 2. The equivalency determination module 220-a may include an education analysis module 405 and a degree mapping module 425.

The education analysis module 405 may analyze the educational inputs and/or the educational measures associated with the educational inputs and may determine an educational achievement based on the educational inputs and their associated educational measures. For example, the education analysis module may analyze the educational measures associated with each input and may determine an overall educational achievement based on the determined educational measures. In some cases, the educational analysis module 405 may include a field analysis sub module 415 and a course analysis sub module 420.

The field analysis module 415 may analyze the distribution of educational inputs in terms of discipline and/or field, and may identify one or more field trajectories based on the analysis of the discipline and/or field and on the determined educational measures (the aggregate educational measures for each field, for example). For example, the field analysis module may analyze the distribution of educational measurements and may identify that the educational achievement has a field trajectory in line with a computer science degree. Additionally or alternatively, the field analysis module 415 may analyze the distribution of the required educational inputs and the educational measures associated with those required educational inputs for a known degree program to determine a required field distribution and the required educational measures for each field.

The course analysis module 420 may analyze the type of subject matter covered in each educational input. For example, the course analysis module 420 may analyze the type of subject matter covered in one or more educational inputs of the user. Additionally or alternatively, the course analysis module 420 may analyze the type of subject matter covered in each required educational input of a known degree program.

The degree mapping module 425 may map the educational achievement of a user to an educational equivalency with respect to a known degree program. For example, the degree mapping module 425 may determine that the educational achievement of a user corresponds to a senior level candidate pursuing an economics degree. In some cases, the degree mapping module 425 may include a degree identification sub module 430, a field comparison sub module 435, a course comparison sub module 440, and a deficiency identification sub module 445.

The degree identification sub module 430 may identify one or more candidate degrees based on the field distribution of the users educational inputs and the educational measures associated with those educational inputs and/or the type of subject matter covered in the users educational inputs. For example, the degree identification sub module 430 may identify one or more known degree programs based on the field analysis and course analysis of the user's educational inputs and their associated educational measures.

The field comparison sub module 435 may compare the field distribution of the user's educational inputs and the educational measures associated with those inputs with the required field distribution and the associated required educational measure of the known degree program. For example, a known degree program may require an aggregate educational measure of 700 in the field of accounting. In this example, the field comparison sub module 435 may compare the education measure of the educational inputs identified in the accounting field with the required educational measure of 700 in the field of accounting. In some cases, the degree mapping module 425 may identify one or more candidate degrees based on the field comparison.

The course comparison sub module 440 may compare the subject matter of each educational input and the educational measure associated with that educational input with the required subject matter of one or more educational inputs (e.g., courses) of a known degree program (e.g., the identified degree program) and the educational measure associated with the required educational inputs. In this way a granular subject matter comparison may be made between required educational input subject matter for a required degree program and the subject matter of the user's educational inputs and their associated educational measures. In some cases, a combination of educational inputs may be required to satisfy the educational measurement requirements for a particular subject matter area.

The deficiency identification sub module 445 may identify any deficiencies between an identified degree and the educational achievement of the user. In some cases, deficiency may be determined based on educational measurement requirements in a required field and/or educational measurement requirements in a required subject matter area.

In some cases, the equivalency determination module 220-a may output (e.g., achievement equivalency 225) the determined educational achievement, the determined educational equivalency, and/or any educational deficiencies for earning each of one or more known degree programs. In some cases, the degree mapping module 425 may map the educational achievement of the user to a variety of degrees, and may indicate to the user the deficiencies for obtaining each of the variety of degrees.

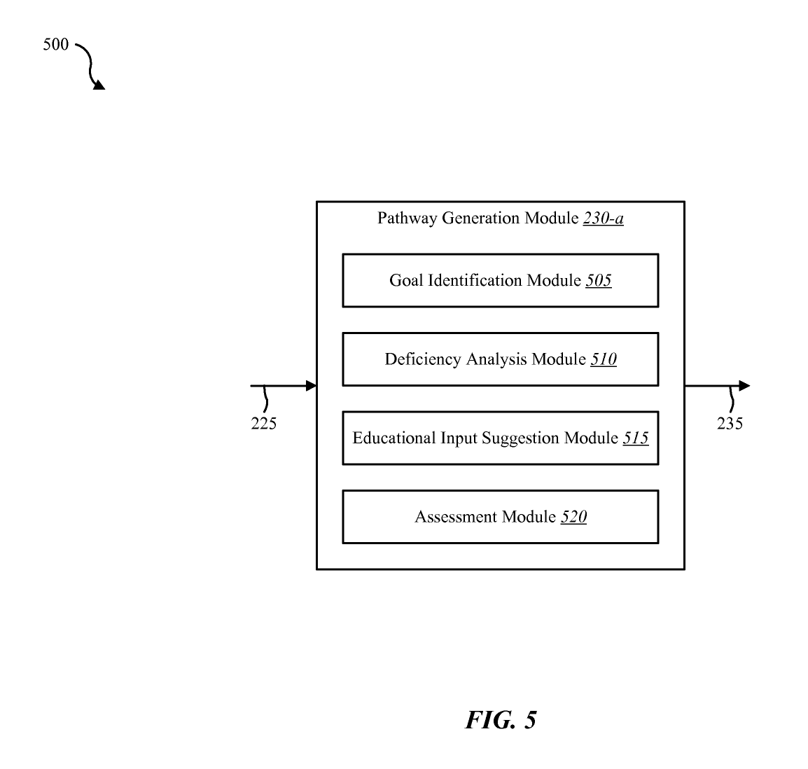

FIG. 5 is a block diagram 500 illustrating one embodiment of a pathway generation module 230-a. The pathway generation module 230-a may be an example of the pathway generation module 230 illustrated in FIG. 2. In some cases, the pathway generation module 230-a may map out one or more pathways for obtaining an identified educational achievement goal. In one example, the pathway generation module 230-a may generate one or more paths of educational inputs that may be used to achieve the identified educational goal. The pathway generation module 230-a may include a goal identification module 505, a deficiency analysis module 510, an educational input suggestion module 515, and an assessment module 520.

The goal identification module 505 may allow the user to select an educational goal (e.g., a known degree program to pursue). In some cases, the goal identification module 505 may display one or more of the identified degree programs for selection by the user. In other cases, the goal identification module 505 may allow the user to search for a desired goal. In some embodiments, the goal identification module 505 may receive input identifying a selected goal.

The deficiency analysis module 505 may analyze the deficiencies between the educational achievement of the user and the required educational achievement of the known degree program. For example, the deficiency analysis module 505 may determine the amount of educational measurement deficient for each field and/or for each subject matter.

The educational input suggestion module 515 may suggest available educational inputs that may be completed to satisfy at least a portion of the deficient required educational measurements. For example, the input suggestion module 515 may display one or more available educational inputs that would satisfy at least a portion of the deficient required educational measurements. In some cases, the educational input suggestion module 515 may suggest multiple available educational inputs with different learning types that would satisfy at least a portion of the deficient required educational measurements. For example, a user may satisfy a deficient educational measurement requirement by attending one or more particular courses (e.g., a formal educational input), completing one or more unaccredited online courses, reading a selection of books and taking an assessment, working for a particular amount of time in a particular field, etc. In some cases, the input suggestion module 515 may update the suggested educational inputs (and the pathway, for example) based on the educational inputs used to fulfill different educational measurement requirements.

The assessment module 520 may assess the user's educational achievement in a particular subject matter and/or field using one or more assessments (e.g., quizzes, tests, etc.). For example, the assessment module 520 may assess the user's educational achievement in a particular field or subject matter area upon completing one or more educational inputs directed to that field or subject matter. In some cases, the assessment module 520 may assess the user's educational achievement in a particular field or area when the educational inputs associated with that field or particular area did not have sufficient assessment of the field or subject matter. For instance, when the learning type for an educational input is reading a textbook (e.g., a physics book), then the assessment module 520 may assess the user's comprehension of the textbook using one or more assessments (asking theoretical physics questions and asking computational physics problems, for example). In one example, an educational measurement may not be associated with an educational input until one or more assessments have been satisfactorily completed (based on threshold, for example).

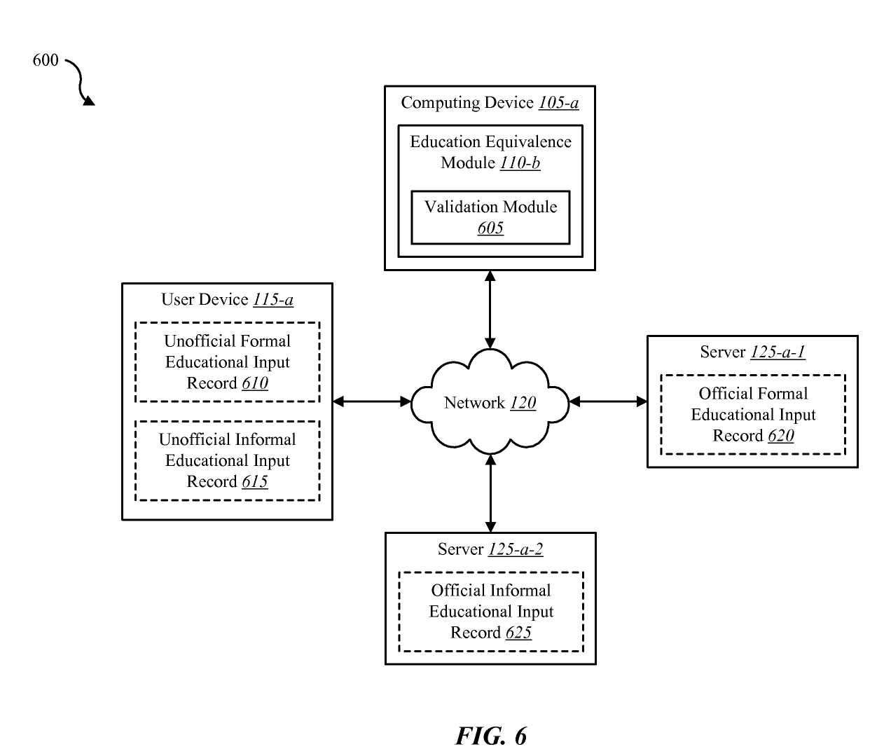

FIG. 6 illustrates an exemplary environment 600 in which the present systems and method may be implemented. The environment 600 includes a computing device 105-a, a user device 115-a, a first server 125-a-1, and a second server 125-a-2. The computing device 105-a, the user device 115-a, and the first and second servers 125-a-1, 125-a-2 may be communicatively coupled via the network 120. The computing device 105-a may be an example of the computing device 105 illustrated in FIG. 1. The computing device 105-a may include an education equivalence module 110-b. The education equivalence module 110-b may be an example of the education equivalence module 110 illustrated in FIG. 1 or 2.

In one example, a user (using the user device 115, for example) may create an account with the education equivalence module 110-b. For example, the education equivalence module 110-b may receive a connection request from the user device 115. Upon connecting with the user device 115, the education equivalence module 110-b may receive an account creation request. The education equivalence module 110-b may create an account for the user of the user device 115. The education equivalence module 110-b may receive one or more educational input records from the user device 115-a. For example, the education equivalence module 110-b may receive one or more unofficial formal educational input records 610 (e.g., unofficial transcripts). In one example, the education equivalence module 110-b may receive additional educational input records. For example, the education equivalence module 110-b may receive an unofficial informal educational input record 615. For instance, the education equivalence module 110-b may receive an indication from the user device 115-a that an informal educational input has been completed.

Additionally or alternatively, the education equivalence module 110-b may monitor one or more servers (e.g., the first and second servers 125-a-1, 125-a-2) for educational input records associated with the user (as identified via the user account, for example). For example, the education equivalence module 110-b may connect to the first server 125-a-1 to obtain an official formal educational input record 620 (e.g., official transcript). For instance, the first server 125-a-1 may be associated with the educational institution (e.g., university) that provided the educational inputs. Similarly, the education equivalence module 110-b may connect to the second server 125-a-2 to obtain an official informal educational input record 625. For instance, the second server 125-a-2 may be associated with the educational provider that provided the educational input associated with the official informal educational input record 625.

In one example, the education equivalence module 110-b may analyze each educational input record and may determine an educational measure for each educational input in the educational input records. In some cases, the education equivalence module 605 may include a validation module 605. In some embodiments, the education equivalence module 110-b may use the validation module 605 to validate unofficial formal educational input records 610 and/or unofficial informal educational input records 615. For instance, upon receiving the unofficial formal educational input record 610 and/or the unofficial informal educational input record 615, the validation module 605 may connect to the first server 125-a-1 and/or the second server 125-a-2 to validate the unofficial formal educational input record 610 with the official formal educational input record 620 and to validate the unofficial informal educational input record 615 with the official informal educational input record 625.

In some cases, the education equivalence module 110-b may determine an educational achievement associated with the user and may identify and educational equivalence between the educational achievement of the user and at least a portion of a known degree program. In one example, the user may select or identify a goal educational achievement. For example, the goal educational achievement may correspond to a known degree program. The education equivalence module 110-b may provide suggested educational input opportunities (e.g., a pathway) to achieve the goal educational achievement.

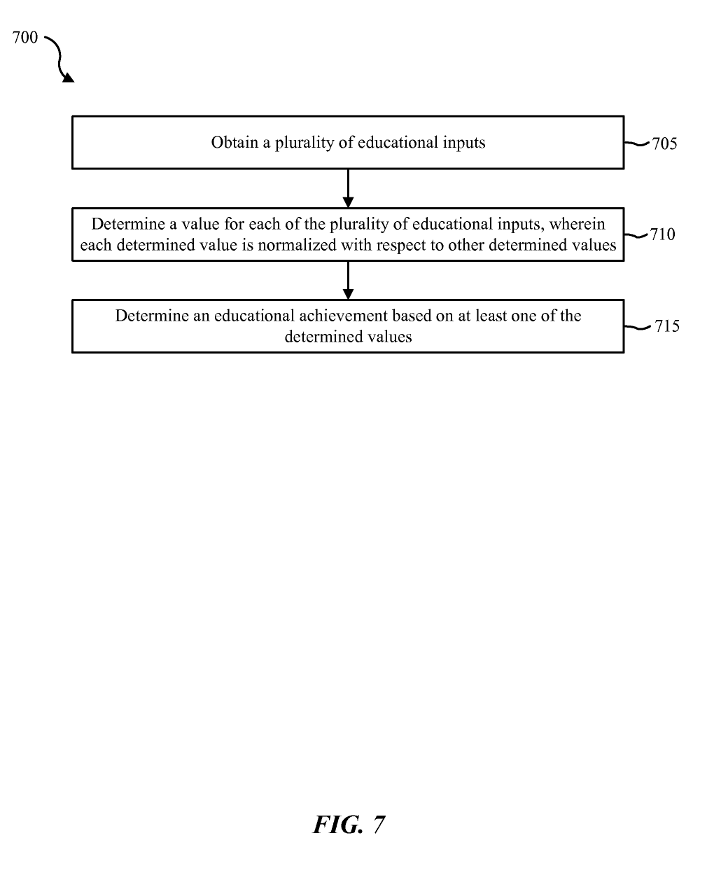

FIG. 7 is a flow diagram illustrating one embodiment of a method 700 to measure educational inputs. In one configuration, the method 700 may be implemented by a computing device 105 such as computing device 105 illustrated in FIG. 1 or 6. In particular, the method 700 may be implemented by the education equivalence module 110 of FIG. 1, 2, or 6.

At block 705, a plurality of educational inputs may be obtained. At block 710, a value may be determined for each of the plurality of educational inputs. Each determined value may be normalized with respect to the other determined values. At block 715, an educational measure may be determined based on at least one of the determined values.

Thus, the method 700 may allow for educational inputs from different learning types and educational inputs from different educational providers to be analyzed and compared together. It should be noted that the method 700 is just one implementation and that the operations of the method 700 may be rearranged or otherwise modified such that other implementations are possible.

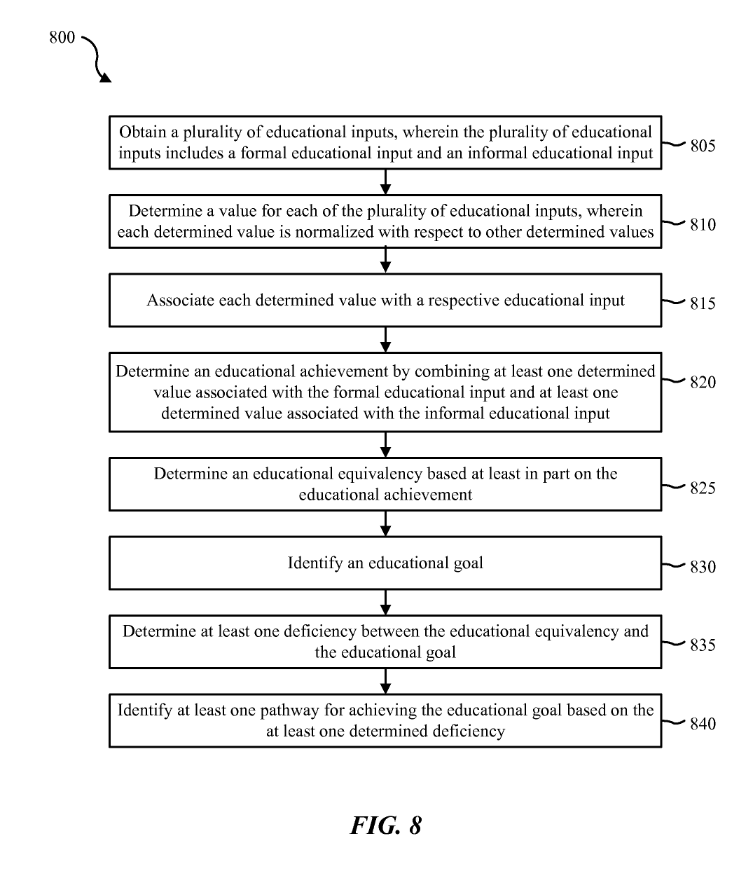

FIG. 8 is a flow diagram illustrating one embodiment of a method 800 to identify at least one pathway for achieving an educational goal. In one configuration, the method 800 may be implemented by a computing device 105 such as computing device 105 illustrated in FIG. 1, 2, or 6. In particular, the method 800 may be implemented by the education equivalency module 110 of FIG. 1, 2, or 6.

At block 805, a plurality of educational inputs may be obtained. For example, the educational inputs may include a formal educational input and an informal educational input. An example of a formal educational input may be completing a course at a formal accredited educational institution. Examples of an informal educational input may be attending a conference, completing a book, or working for a particular period of time at a particular position in industry, etc.

At block 810, a value (e.g., educational measure) may be determined for each of the plurality of educational inputs. Each determined value may be normalized with respect to other determined values. For example, the value associated with the formal educational input may be normalized with respect to the value associated with the informal educational input.

At block 815, each determined value may be associated with a respective educational input. At block 820, an educational achievement may be determined by combining at least one determined value associated with the formal educational input and at least one determined value associated with the informal educational input. At block 825, an educational equivalency may be determined based at least in part on the educational achievement. For example, the educational equivalency may correspond to a portion of the educational achievement that may be used to satisfy requirements of a known degree program.

At block 830, an educational goal may be identified. At block 835, at least one deficiency between the educational equivalency and the educational goal may be determined. At block 840, at least one pathway may be identified for achieving the educational goal may be identified based on the at least one determined deficiency.

Thus, the method 800 may identify at least one pathway for achieving an educational goal. It should be noted that the method 800 is just one implementation and that the operations of the method 800 may be rearranged or otherwise modified such that other implementations are possible.

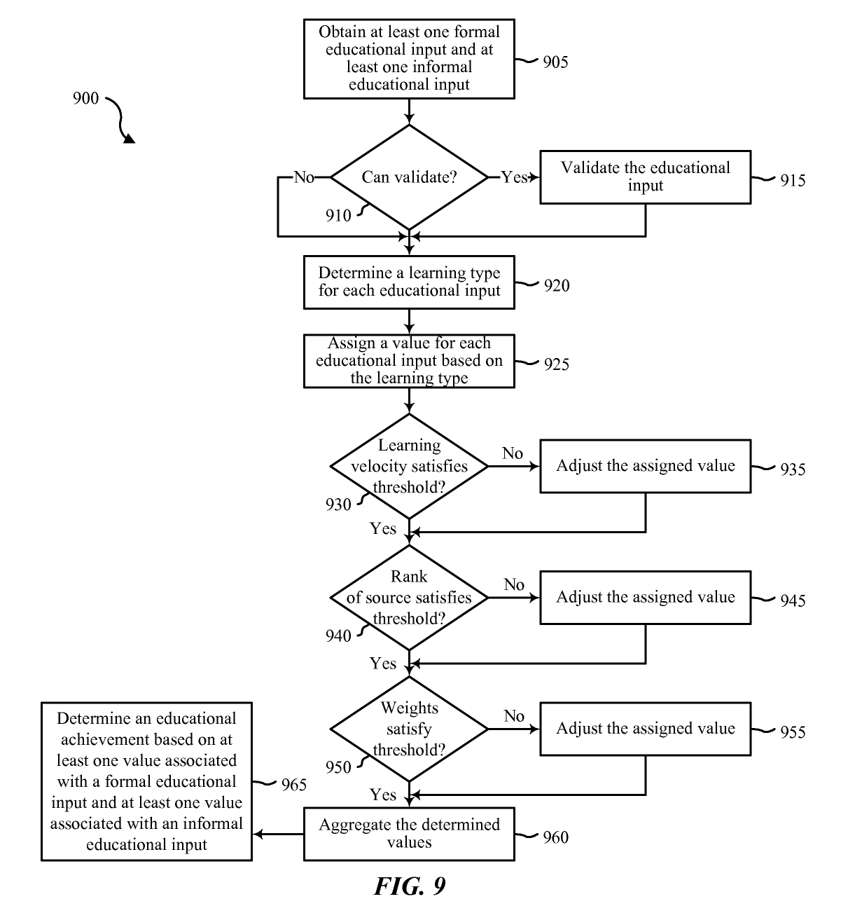

FIG. 9 is a flow diagram illustrating one embodiment of a method 900 to determine educational achievement based on educational inputs from different educational providers. In one configuration, the method 900 may be implemented by a computing device 105 such as computing device 105 illustrated in FIG. 1 or 6. In particular, the method 900 may be implemented by the education equivalence module 110 of FIG. 1, 2, or 6.

At block 905, a plurality of educational inputs may be obtained including at least one formal educational input and at least one informal educational input. At block 910, a determination is made as to whether the educational input can be validated. If the educational input can be validated, then at block 915, the educational input may be validated. If, however, the educational input cannot be validated, then operation proceeds to block 920. At block 920, a learning type may be determined for each educational input. At block 925, a value may be assigned for each educational input based on the learning type of each respective educational input. For example, more rigorous learning types may be assigned a higher value (e.g., educational measure). In some cases, assigning a value based on learning type may result in a normalization of educational inputs of different learning types.

At block 930, a determination is made as to whether a learning velocity satisfies a threshold. For example, the learning velocity may be the rate of learning. In some cases, each learning type may be associated with a particular learning velocity range. If information is received that indicates a learning velocity that is higher or lower than the typical learning velocity range, then at block 935, the assigned value may be adjusted accordingly (e.g., increasing for increased learning velocity, decreasing for decreased learning velocity). If the learning velocity is within the typical range (e.g., satisfies a threshold), then operation proceeds to block 940.

At block 940 a determination is made as to whether the rank of the source of the educational input satisfies a threshold. For example, sources may be ranked based on academic rigor, prestige, etc. If the rank of the source for the educational input exceeds a threshold (e.g., is above or below the normal range), then at block 945, the assigned value may be adjusted accordingly (e.g., increased for better ranking, decreased for worse ranking). If the rank of the source of the educational provider is within the typical range (e.g., satisfies a threshold), then operation proceeds to block 950.

At block 950 a determination is made as to whether the weighting associated with the assigned value is within a range of typical weighting (e.g., satisfies a threshold). In some cases, the nature of the educational input requires an adjustment of the weighting of the different factors that play into the assigned value associated with the educational input. For example, receiving an educational input (e.g., formal course) from the best department of the best school in the nation ma result in weighting the source (e.g., school and/or department) higher than it is normally weighted. In such cases, if the weightings associated with the assigned value do not satisfy a threshold, then, at block 955, the weighting of the assigned value may be adjusted, which may result in an adjustment of the assigned value. If the weighting of the assigned value is within the range of traditional weightings (e.g., satisfies a threshold), then operation proceeds to block 960.

At block 960, the determined values may be aggregated. In some cases, each of the determined values may be normalized with respect to each other, allowing for proper analysis and comparison. At block 965, an educational achievement may be determined based on at least one value associated with a formal educational input and at least one value associated with an informal educational input.

Thus, the method 900 may allow for educational inputs from different learning types and educational inputs from different educational providers to be analyzed and compared together. It should be noted that the method 900 is just one implementation and that the operations of the method 900 may be rearranged or otherwise modified such that other implementations are possible.

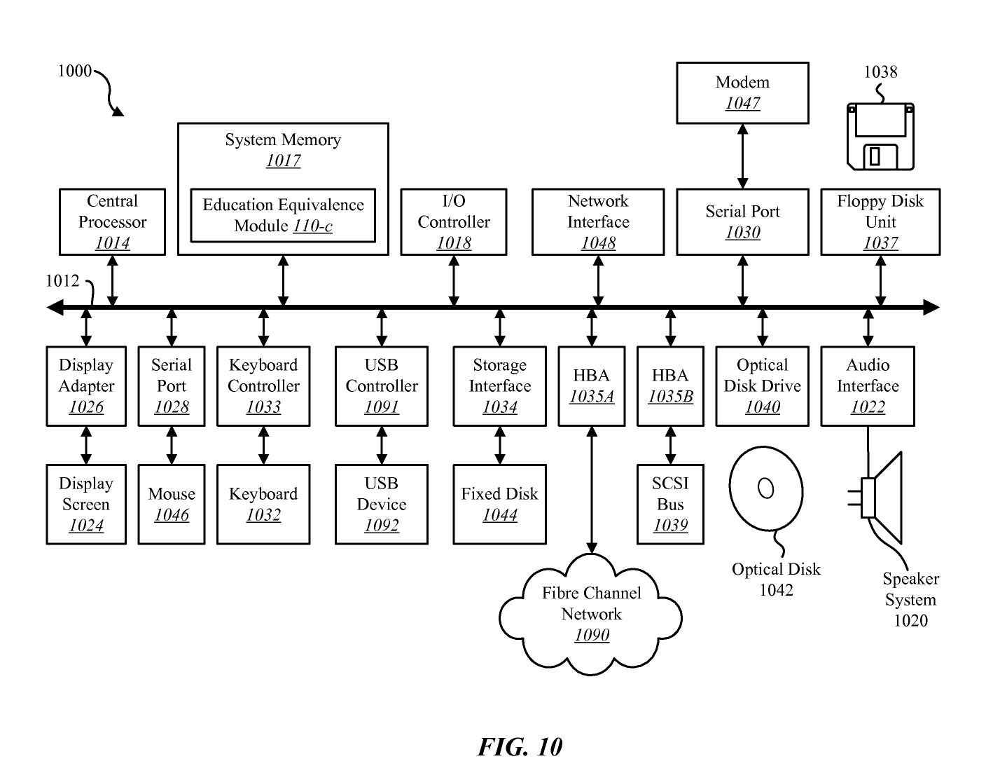

FIG. 10 depicts a block diagram of a computer system 1000 suitable for implementing the present systems and methods. Computer system 1000 includes a bus 1012 which interconnects major subsystems of computer system 1010, such as a central processor 1014, a system memory 1017 (typically RAM, but which may also include ROM, flash RAM, or the like), an input/output controller 1018, an external audio device, such as a speaker system 1020 via an audio output interface 1022, an external device, such as a display screen 1024 via display adapter 1026, serial ports 1028 and 1030, a keyboard 1032 (interfaced with a keyboard controller 1033), multiple USB devices 1092 (interfaced with a USB controller 1091), a storage interface 1034, a floppy disk unit 1037 operative to receive a floppy disk 1038, a host bus adapter (HBA) interface card 1035A operative to connect with a Fibre Channel network 1090, a host bus adapter (HBA) interface card 1035B operative to connect to a SCSI bus 1039, and an optical disk drive 1040 operative to receive an optical disk 1042. Also included are a mouse 1046 (or other point-and-click device, coupled to bus 1012 via serial port 1028), a modem 1047 (coupled to bus 1012 via serial port 1030), and a network interface 1048 (coupled directly to bus 1012).

Bus 1012 allows data communication between central processor 1014 and system memory 1017, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, an education equivalence module 110-c to implement the present systems and methods may be stored within the system memory 1017. The education equivalence module 110-c may be an example of the education equivalence module 110 of FIG. 1, 2, or 6. Applications resident with computer system 1000 are generally stored on and accessed via a non-transitory computer readable medium, such as a hard disk drive (e.g., fixed disk 1044), an optical drive (e.g., optical drive 1040), a floppy disk unit 1037, or other storage medium. Additionally, applications can be in the form of electronic signals modulated in accordance with the application and data communication technology when accessed via network modem 1047 or interface 1048.

Storage interface 1034, as with the other storage interfaces of computer system 1000, can connect to a standard computer readable medium for storage and/or retrieval of information, such as a fixed disk drive 1044. Fixed disk drive 1044 may be a part of computer system 1000 or may be separate and accessed through other interface systems. Modem 1047 may provide a direct connection to a remote server via a telephone link or to the Internet via an internet service provider (ISP). Network interface 1048 may provide a direct connection to a remote server via a direct network link to the Internet via a POP (point of presence). Network interface 1048 may provide such connection using wireless techniques, including digital cellular telephone connection, Cellular Digital Packet Data (CDPD) connection, digital satellite data connection, or the like.

Many other devices or subsystems (not shown) may be connected in a similar manner (e.g., document scanners, digital cameras, and so on). Conversely, all of the devices shown in FIG. 10 need not be present to practice the present systems and methods. The devices and subsystems can be interconnected in different ways from that shown in FIG. 10. The operation of a computer system such as that shown in FIG. 10 is readily known in the art and is not discussed in detail in this application. Code to implement the present disclosure can be stored in a non-transitory computer-readable medium such as one or more of system memory 1017, fixed disk 1044, optical disk 1042, or floppy disk 1038. The operating system provided on computer system 1000 may be MS-DOS®, MS-WINDOWS®, OS/2®, UNIX®, Linux®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.”

What is claimed is:

1. A computer-implemented method for measuring educational inputs, comprising:
obtaining a plurality of educational inputs;
determining a value for each educational input, wherein each determined value is normalized with respect to other determined values; and
determining an educational achievement based on at least one of the determined values.

2. The method of claim 1, wherein the plurality of educational inputs includes at least one informal educational input.

3. The method of claim 2, wherein the plurality of educational inputs includes at least one formal educational input.

4. The method of claim 3, wherein the educational achievement is determined by combining at least one determined value for the at least one informal educational input and at least one determined value for the at least one formal educational input.

5. The method of claim 1, wherein determining the value for each educational input comprises:
determining a learning velocity for each educational input; and
determining the value for each educational input based on the learning velocity of each educational input.

6. The method of claim 1, wherein determining the value for each educational input comprises:
determining a weighting for each educational input;
determining a rank for each educational input; and
determining the value for each educational input based on the weighting and the rank of each educational input.

7. The method of claim 1, further comprising:
determining an educational equivalency based at least in part on the educational achievement.

8. The method of claim 7, further comprising:
generating an educational goal; and
identifying at least one pathway for achieving the educational goal, wherein the pathway is based on the determined educational equivalency.

9. The method of claim 1, further comprising:
categorizing each of the determined values;
combining the determined values based on category; and
determining a category measurement for at least one category based on the combined determined values.

10. The method of claim 1, further comprising:
validating at least one of the plurality of educational inputs.

11. A device configured to measure educational inputs, comprising:
a processor; and
memory in electronic communication with the processor; and
instructions stored in the memory, the instructions being executable by the processor to:
obtain a plurality of educational inputs;
determine a value for each educational input, wherein each determined value is normalized with respect to other determined values; and
determine an educational achievement based on at least one of the determined values.

12. The device of claim 11, wherein the plurality of educational inputs includes at least one informal educational input.

13. The device of claim 12, wherein the plurality of educational inputs includes at least one formal educational input.

14. The device of claim 13, wherein the educational achievement is determined by combining at least one determined value for the at least one informal educational input and at least one determined value for the at least one formal educational input.

15. The device of claim 11, wherein the instructions to determine the value for each educational input comprise instructions executable to:
determine a learning velocity for each educational input; and
determine the value for each educational input based on the learning velocity of each educational input.

16. The device of claim 11, wherein the instructions to determine the value for each educational input comprise instructions executable to:
determine a weighting for each educational input;
determine a rank for each educational input; and
determine the value for each educational input based on the weighting and the rank of each educational input.

17. The device of claim 11, wherein the instructions are further executable to:
determine an educational equivalency based at least in part on the educational achievement.

18. The device of claim 17, wherein the instructions are further executable to:
generate an educational goal; and
identify at least one pathway for achieving the educational goal, wherein the pathway is based on the determined educational equivalency

19. The device of claim 11, wherein the instructions are further executable to:
categorize each of the determined values;
combine the determined values based on category; and
determine a category measurement for at least one category based on the combined determined values.

20. A computer-program product to measure educational inputs, the computer-program product comprising a non-transitory computer-readable medium having instructions thereon, the instructions being executable by a processor to:
obtain a plurality of educational inputs;
determine a value for each educational input, wherein each determined value is normalized with respect to other determined values; and
determine an educational achievement based on at least one of the determined values.
